(19) United States
(12) Patent Application Publication
(10) Pub. No.: US 2019/0056262 A1
(43) Pub. Date: Feb. 21, 2019

(54) SYSTEM FOR MEASURING AND MONITORING WEIGHT AND VOLUME OF AN OBJECT OR A PORTION THEREOF

(71) Applicant: EMBRYYO TECHNOLOGIES PVT. LTD, Maharashtra (IN)

(72) Inventors: NISHANT KUMAR, PUNE (IN); PRATEEK JAIN, UDAIPUR (IN)

(21) Appl. No.: 16/078,143

(22) PCT Filed: Jan. 30, 2017
(86) PCT No.: PCT/IB2017/050474

§ 371 Date: Aug. 21, 2018

(30) Foreign Application Priority Data
Feb. 22, 2016 (IN) 3621/MUM/2015

(51) Int. Cl. G01G 19/44; G01G 19/50; G01F 17/00

(52) U.S. Cl. CPC G01G 19/445; G01F 17/00; G01G 19/50

(57) ABSTRACT

The present disclosure relates to a system that measures weight and volume of a targeted animate object or its portion thereof, typically the symphysis pubis region in a pregnant woman or the cranium region of an infant. The system uses this information to compute the estimated weight and volume of its internal constituents such as a fetus of the pregnant woman or a brain of the infant. The system of the present disclosure can compute and monitor weight and volume of the internal constituents of an animate object without the need of advanced imaging modalities such as ultrasonography and magnetic resonance imaging. The system comprises a processor, a rules repository, a first data repository, and the apparatus which includes a weight sensing unit, a volume sensing unit, and a computational module, for implementation purpose.

### FIELD

The present disclosure relates to a system that measures weight and volume of an object or a portion thereof and tracks the growth of the object and its internal constituents.

### Definitions

As used in the present disclosure, the following terms are generally intended to have the meaning as set forth below, except to the extent that the context in which they are used indicate otherwise.

Mattress—The mattress hereinafter refers to a platform or a table on which a body to be weighed can be rested.

### BACKGROUND

Conventional systems that are used to measure the volume and weight of complex and irregular shaped animate or inanimate objects or a portion thereof and its internal constituents require highly trained technicians and sophisticated instrumentation including advanced imaging modalities and measurement systems. Further, the cost of establishment and use of conventional systems such as MRI, CT Scanner or Ultrasound system are high. In some conventional systems, such as use of measuring tapes, the chances of measurement errors are also large. In some other conventional systems, such measurements are possible using simple tools and methods but they have low sensitivity, therefore, the calculated measurement is prone to errors. Such measurements also are not able to reveal any information about the internal constituents of the object or the portion thereof. Other drawbacks associated with conventional systems are inter and intra operator variability, poor sensitivity and poor documentation.

Take an example of a newborn, who undergoes an unmatched growth and development in the first year of its life. From a neurological perspective, the whole brain volume of an infant grows to about two-thirds in the first 3 months of life alone. Several factors which can adversely impact a normal growth trajectory of the brain during this phase might include—acute brain injury in early infancy, developmental disorders such as autism or ADHD, environmental factors such as malnutrition, genetic defects for example Williams or Downs Syndrome and chronic conditions such as cerebral palsy. The rapid growth of axono-dendritic connections and myelination hence puts the newborn into a very vulnerable position as well in its first year of life in the context of neuronal organization and development. Unfortunately, there are only a few tools available which are applicable for an early assessment of brain growth in a routine clinical practice. Advanced neuroimaging techniques, although well-established for adult patients, are often unsuitable for infants. CT, PET and SPECT have the inherent risk of radiation exposure, while MRI requires minimal motion artefacts and/or sedated infants. Non-invasive techniques such as EEG and fNIRS are suitable for functional studies of brain response but cannot be used for physical growth assessment of the brain. One of the simplest tools used for such a physical assessment is the head circumference measurement; however it is used as a surrogate measurement of brain size and brain growth and is only imperfectly correlated with brain volume. Moreover, the method lacks sensitivity and suffers from inter and intra-operator variability. Consequently, there is a dire unmet need for a cost-effective, bedside, harmless, easy-to-use and sensitive tool for the estimation of brain weight and volume in infants as a means to distinguish abnormal from normal brain growth trajectories at the earliest possible time instant in the first year of life for every newborn.

Hence, there is a need for a system and for measuring weight and volume of an animate or an inanimate object or a portion thereof that: (i) can be performed by unskilled technicians, (ii) reduces measurement errors and (iii) is comparatively less expensive, and (iv) aids in monitoring the growth of an animate and/or an inanimate object or a portion thereof and one or more of its internal constituents.

### OBJECTS

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a weight and volume measuring and monitoring system that reduces measurement errors.

Another object of the present disclosure is to provide a weight and volume measuring and monitoring system that increases the accuracy of measurements when used in conjunction with the conventional systems.

Another object of the present disclosure is to provide a weight and volume measuring and monitoring system that takes less time.

Still another object of the present disclosure is to provide a weight and volume measuring and monitoring system that is cost-effective.

Yet another object of the present disclosure is to provide a weight and volume measuring and monitoring system that is easy to understand and operate.

Still another object of the present disclosure is to provide a weight and volume measuring and monitoring system that can be performed by unskilled technician.

Still another object of the present disclosure is to provide a weight and volume measuring and monitoring system that is efficient and safe.

Still another object of the present disclosure is to provide a weight and volume measuring and monitoring system that can be used to track parameters related to the growth of an object or one or more of its internal constituents.

Other objects and advantages of the present disclosure will be more apparent from the following description when read in conjunction with the accompanying drawing, which are not intended to limit the scope of the present disclosure.

### SUMMARY

The present disclosure envisages a system for measuring and monitoring weight and volume of an object or a portion thereof at periodic intervals to track the growth of said object or a portion thereof. The system also estimates the growth trajectories of the internal constituents present inside the object or the portion. The system comprises a rules repository, a processor, a weight sensing unit, a volume sensing unit, and a first data repository.

The processor is configured to receive predetermined set of rules from the rules repository and is further configured to generate system processing commands. The weight sensing unit is configured to, under the system processing commands, measure load of the object or a portion thereof, and is further configured to generate and transmit weight signals. The volume sensing unit is configured to, under the system processing commands, scan or capture images of the object or a portion thereof and is further configured to generate contour signals corresponding to an outer profile of the scanned object or captured image of the object. The first data repository is configured to store pre-determined set of rules, guidelines and mathematical formulae.

The processor is configured to receive the weight signals to generate and store digital values of measured weight of the object or a portion thereof corresponding to received weight signals. Further, the processor is configured to receive the mathematical formulae and the contour signals from the first data repository and the volume sensing unit respectively, to compute and store volume of the object or a portion thereof corresponding to the contour signals using the mathematical formulae.

The system further comprises a computational module, a second data repository and a display unit. The computational module is in communication with the processor and is configured to, under system processing commands, generate the digital values of weight and compute the volume of the object or a portion thereof using the mathematical formulae. The second data repository is configured to store the digital values of measured weight and the computed volume. The display unit is configured to display the measured weight and computed volume of the object or a portion thereof.

In an embodiment, the weight sensing unit of the system is a flexible mattress which is defined by a plurality of slats. Each of the plurality of slats has at least one load cell to measure load subjected thereon. The at least one load cell is configured to generate the weight signals corresponding to the measured load.

In another embodiment, the weight sensing unit of the system is an air mattress which is defined by a plurality of sections. Each of the plurality of sections has at least one pressure sensor to measure load subjected thereon. The at least one pressure sensor is configured to generate the weight signals corresponding to the measured load. Each of the plurality of sections is filled with air separately to measure load of portions of the object independently.

In an embodiment, the volume sensing unit comprises a scanner which is configured to scan the object or a portion thereof. In another embodiment, the volume sensing unit comprises at least one camera which is configured to capture images of the object or portion thereof. In yet another embodiment, the volume sensing unit comprises a laser beam source and a camera, wherein the laser beam source is configured to project a plurality of laser beams on the object or a portion thereof, and the camera is configured to capture images of the plurality of laser beams impinged on the object or a portion thereof.

In an exemplary embodiment, the volume sensing unit further comprises a frame on which the scanner or the camera or he laser beam source is mounted, wherein the frame is configured to traverse along the length of said object or a portion thereof. The frame includes at least one arcuate rail on which the scanner or the camera or the laser beam source is mounted, such that the at least one arcuate rail facilitates traversing of the scanner or the camera or the laser beam source along the width of the object or a portion thereof.

### BRIEF DESCRIPTION

A system for measuring and monitoring weight and volume of an object or a portion thereof, of the present disclosure will now be described with the help of an accompanying drawing, in which:

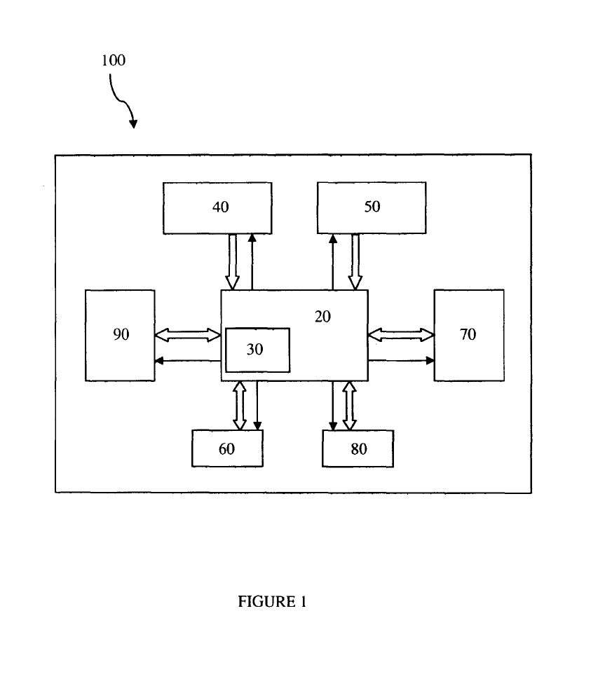

FIG. 1 illustrates a block diagram of the system for measuring and monitoring weight and volume of an object or a portion thereof, in accordance with an embodiment of the present disclosure;

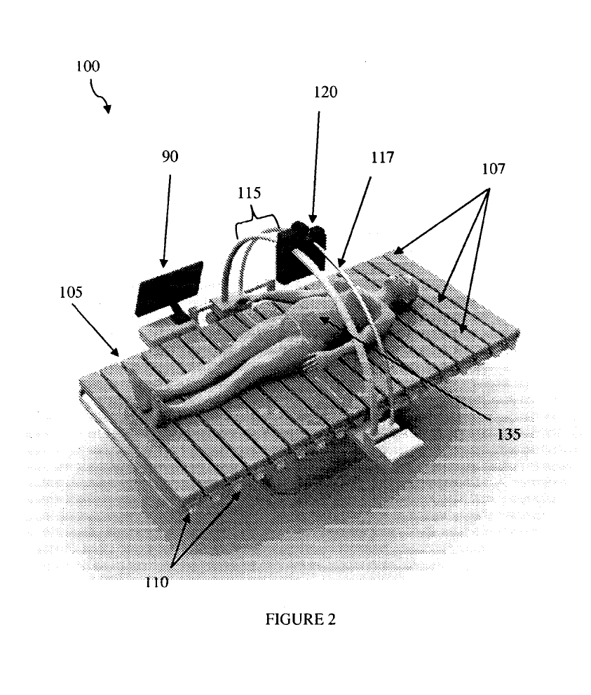

FIG. 2 illustrates an isometric view of components of the system for measuring weight and volume of an object or a portion thereof, in accordance with an embodiment of the present disclosure;

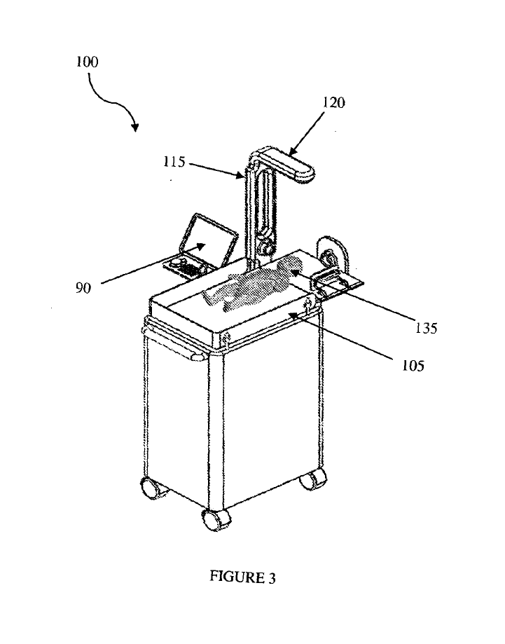

FIG. 3 illustrates an isometric view of the components of the system for measuring weight and volume of an object or a portion thereof, in accordance with another embodiment of the present disclosure;

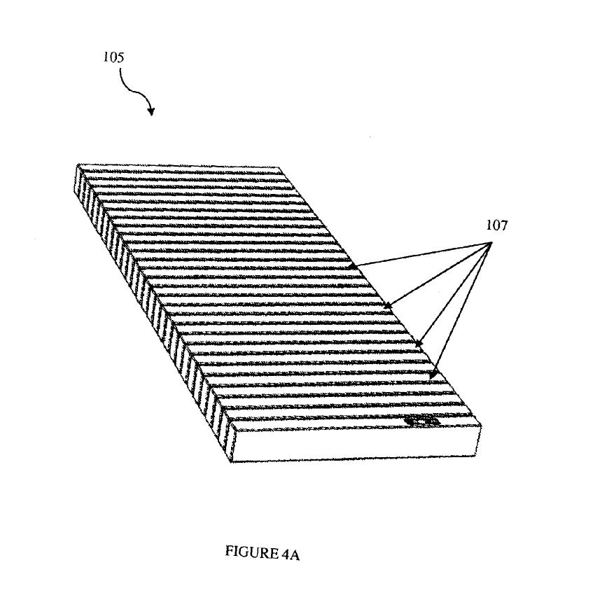

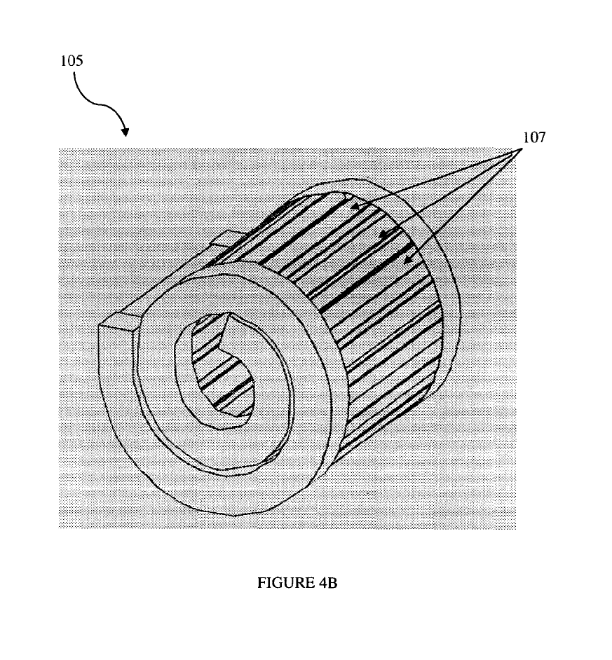

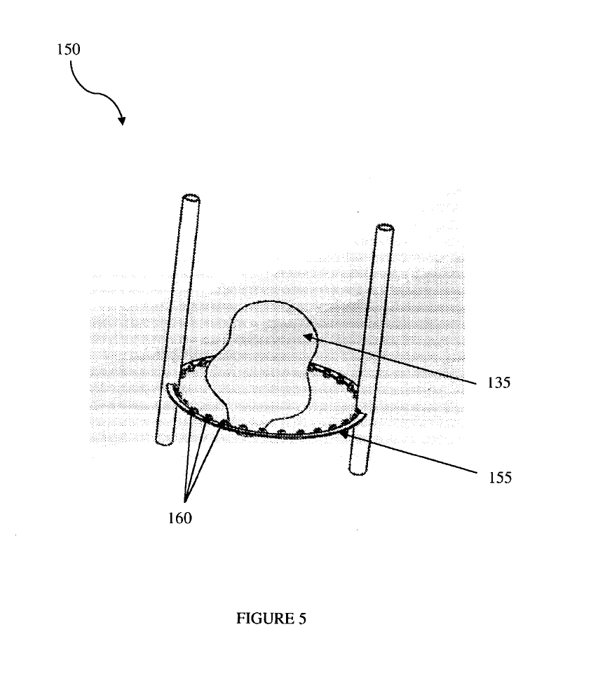

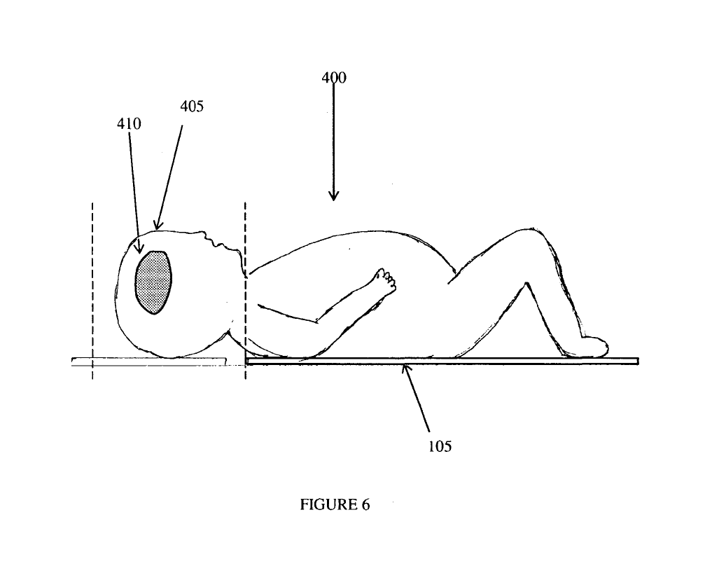

FIG. 4A and FIG. 4B illustrate an isometric view of a flexible mattress of the system, in accordance with an embodiment of a weight sensing unit of the present disclosure; and

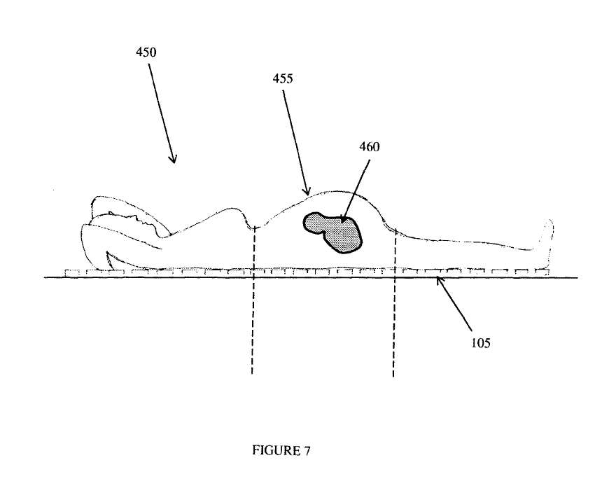

FIG. 5 illustrates an isometric view of a volume measuring ring unit, in accordance with an embodiment of a volume sensing unit of the present disclosure.

### DETAILED DESCRIPTION

Conventional systems that are used to measure the volume and weight of complex and irregular shaped animate or inanimate objects or a portion thereof require highly trained technicians and sophisticated instrumentation including advanced imaging modalities and measurement systems. Further, the cost of establishment and use of conventional systems is high. Also, in some conventional systems the chances of measurement errors are large. In some other conventional systems, such measurements are possible using simple tools and methods but they have low sensitivity, therefore, the calculated measurement is prone to errors, for example in the case of measuring tapes. Such measurements also are not able to reveal any information about the internal constituents of the object or the portion thereof. Other drawbacks associated with conventional systems are inter and intra operator variability, poor sensitivity and poor documentation.

The present disclosure envisages a system for measuring and monitoring weight and volume of an object or a portion thereof that alleviates the abovementioned drawbacks of conventional systems. The system for measuring and monitoring weight and volume, in accordance with an embodiment of the present disclosure will now be described with reference to the embodiments, which do not limit the scope and ambit of the disclosure. The description provided is purely by way of example and illustration. The embodiment herein, the various features, and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced, and to further enable those of skill in the art to practice the embodiments herein. Accordingly, the examples should not be construed as limiting the scope of the embodiments herein. The system of the present disclosure has been described herein with reference to FIG. 1 through FIG. 5.

FIG. 1 illustrates a block diagram of a system 100 for measuring and monitoring weight and volume of an object or a portion thereof, in accordance with an embodiment of the present disclosure. FIG. 2 and FIG. 3 illustrate isometric views of components of the system 100, in accordance with different embodiments of the present disclosure respectively. FIG. 4A and FIG. 4B illustrate isometric views of a flexible mattress of the system 100 in different operative configuration, in accordance with an embodiment of a weight sensing unit of the present disclosure. FIG. 5 illustrates an isometric view of a volume measuring ring unit, in accordance with an embodiment of a volume sensing unit of the present disclosure. The system 100 for measuring and monitoring weight and volume of an object or a portion thereof 135 hereinafter will also be referred as the “the system 100”. The term “the object or a portion thereof” hereinafter will also be referred as “the targeted object” for easy reference.

The system 100 is configured to measure weight and volume of an animate or an inanimate object 135 or a portion thereof at periodic intervals. Such periodic measurements help in tracking the growth of the object or a portion thereof and one or more of its internal constituents for monitoring purpose and for the purpose of providing a feedback correspondingly. In an embodiment, the periodic measurements are used to estimate the growth trajectories of internal constituents of the object or its portion. The system 100 typically comprises a processor 20, a rules repository 30, a weight sensing unit 40, a volume sensing unit 50, and a first data repository 60. The processor 20 is configured to receive predetermined set of rules from the rules repository 30 and is further configured to generate system processing commands. The processor 20 is further configured to instruct the weight sensing unit 40, the volume sensing unit 50, and the first data repository 60 as per the processing commands.

The weight sensing unit 40 of the system 100 is configured to, under the system processing commands, measure load of the targeted object 135, and is further configured to generate weight signals corresponding to the measured load and transmit the generated signals to the processor 20. The processor 20 is configured to receive the weight signals to generate and store digital values of measured weight of the targeted object 135 corresponding to received weight signals.

In an embodiment, the weight sensing unit 40 is a flexible mattress 105 which is defined by a plurality of slats 107 (as shown in FIG. 2, FIG. 4A and FIG. 4B). In an operative configuration, the targeted object 135 is placed on the flexible mattress 105. Each of the plurality of slats 107 is fitted with at least one load cell 110 to measure load subjected thereon. In one embodiment, the at least one load cell 110 is fitted below each of the plurality of slats 107. The at least one load cell 110 is configured to generate the weight signals corresponding to the measured load. The flexible mattress 105 can be made compact by rolling it so as to minimize the space occupied by it in a non-operative configuration, as shown in FIG. 4B. In an embodiment, the processor 20 is configured to measure weight corresponding to the transmitted weight signals from a sequence of load cells 110 in a pre-determined manner.

In another embodiment, the weight sensing unit 40 is an air mattress (not shown in the figures) which is defined by a plurality of sections (not shown in the figures). In an operative configuration, the targeted object 135 is placed on the air mattress. Each of the plurality of sections is configured to have at least one pressure sensor (not shown in the figures) to measure load subjected thereon. The at least one pressure sensor is configured to generate the weight signals corresponding to the measured load. Each of the plurality of sections is filled with air separately to measure load of the targeted object 135 or the targeted portions of the object independently.

The volume sensing unit 50 of the system 100 is configured to, under the system processing commands, scan or capture images of the targeted object 135 and is further configured to generate contour signals corresponding to an outer profile of the scanned image or captured image of the targeted object 135. The volume sensing unit 50 transmits the generated contour signals to the processor 20.

The first data repository 60 of the system 100 is configured to store pre-determined set of rules, guidelines and mathematical formulae. The first data repository 60 is further configured to, under the system processing command, select the appropriate mathematic formulae as per the rules and guidelines and transfer it to the processor 20.

The processor 20 is configured to receive the selected mathematical formulae and the contour signals from the first data repository 60 and the volume sensing unit 50 respectively, to compute and store volume of the targeted object 135 corresponding to the contour signals by using the transferred mathematical formulae.

In an embodiment of the volume sensing unit 50, the volume sensing unit 50 comprises a scanner 120 which is configured to scan the targeted object 135. In another embodiment, the volume sensing unit 50 comprises at least one camera (not shown in the figures) which is configured to capture images of the targeted object 135. In yet another embodiment, the volume sensing unit 50 comprises a laser beam source (not shown in the figures) and a camera (not shown in the figures), wherein the laser beam source is configured to project a plurality of laser beams (not shown in the figures) on the targeted object 135, and the camera is configured to capture images of the plurality of laser beams impinged on the targeted object 135.

In an operative configuration of the above embodiment, the volume sensing unit 50 further comprises a frame 115 on which the scanner 120 or the camera or the laser beam source is mounted. In an embodiment, the frame 115 is configured to traverse along the length of the targeted object 135. In another embodiment, the frame 115 includes at least one arcuate rail 117 on which the scanner 120 or the camera or the laser beam source is engaged, such that the at least one arcuate rail 117 facilitates traversing of the scanner 120 or the camera or the laser beam source along the width of the targeted object 135 to obtain latitudinal readings of the targeted object 135.

In another embodiment of the volume sensing unit 50, the volume sensing unit 50 is a volume measuring ring unit 150 comprising a ring 155 and a plurality of proximity sensors 160. The plurality of proximity sensors 160 is mounted on the operative inner surface of the ring 155. The plurality of proximity sensors 160 is configured to detect the presence of the targeted object 135 and generate contour signals corresponding to an outer profile of the targeted object 135. In an operative configuration, the ring 155 is passed through the targeted object 135 in such a way that the plurality of proximity sensors 160 is able to determine the outer profile of the targeted object 135.

In an embodiment of the present disclosure, the system further comprises a computational module 70, a second data repository 80, and an interfacing unit 90. The computational module 70 is configured to be in communication with the processor 20. The computational module 70 is further configured to, under system processing commands, generate the digital values of weight and compute the volume of the targeted object 135 using the weight signals, the contour signals and the transferred mathematical formulae. In an embodiment, the computational module 70 is also configured to estimate or predict the trends in growth of animate or inanimate objects by extracting and analyzing the weight and volume data measured by the system 100.

The second data repository 80 is configured to store the digital values of measured weight and the computed volume of the targeted object 135. In an embodiment, the second data repository 80 keeps a track of the historic volume and weight measurements of the targeted object 135 for monitoring purpose. In one embodiment, the estimation and prediction of the trends in growth of animate or inanimate objects done by the computational module 70 is facilitated by comparing the measured weight and volume data of the targeted object 135 with: (i) the historic data of weight and volume of the targeted object 135 stored in the second data repository 80, and (ii) the standard templates and patterns stored in the second data repository 80. In an embodiment, the processor 20 is configured to compute the weight and volume of one or more of the internal constituents of the object or its portion thereof using the stored measured weight and the stored computed volume of the object or its portion thereof.

The interfacing unit 90 is configured to display the measured weight and computed volume of the targeted object 135 on a screen. In an embodiment, the interfacing unit 90 provides an interface to a user for sending and receiving information associated with the measurements and monitoring of growth of the targeted object 135.

In an alternative operative embodiment of the present disclosure, the frame 115 can be decoupled with a bed (not labelled in the figures) on which the flexible mattress 105 or air mattress is placed. The frame 115 can be mounted on a movable trolley (not labelled in the figures) and also the load cell mattress can be just fixed onto the existing patient bed (as shown in the FIG. 3).

In another alternative operative embodiment, the scanner 120 is configured to scan the targeted object 135 and is further configured to capture images of the surfaces of the targeted object 135. These captured images are fed to the computational module 70 and in conjunction with the weight signals from the at least one load cell 110 are configured to compute the volume of either the whole object or a portion thereof as required.

The targeted object 135, whose weight and/or volume, is required to be determined can be set by a user with the help of the interfacing unit 90. In accordance with a training phase of the system 100, readings of standard animate or inanimate objects are captured. These readings relating to weight and/or volume of the prospective targeted object 135 are in relation to the growth of the object, for example in the case of an inanimate object, the readings of weight and volume may be in relation to the growth of the object by additive manufacturing such as 3D printing. Similarly, in the case of an animate object such as a baby or pregnant women, specific areas of growth including their body parts such as brain inside an infant, fetus inside a pregnant woman, and tumor inside the body, may be measured and a standard pattern may be obtained. In one embodiment, the measurement may relate to the cranium portion of a baby, wherein the system 100 assists in determining the weight and volume of the cranium portion of a normal baby. Another example of a growing animate object may be a growing fruit or tumor in which case the growing fruit or the body part is rested on the mattress. Further, an inanimate object may be an object being formed by the rapid prototyping process or by 3D printing where an object grows layer by layer.

In another embodiment, the system 100 is used to estimate the density of the tissue of the breast. The estimation of the density of the tissue is particularly useful as a means of early prognosis of breast cancer. In this case, the targeted object 135 may be the part of the breast having that particular tissue whose density is to be estimated.

In actual use, the readings provided by the system 100 may be compared with the stored readings or standard readings that were determined during the training phase of the system 100 to determine deviations, if any. Thus, the processor 20 may include a comparator module (not shown in the figures) and the second data repository 80 for storing and retrieving the standard readings for the purposes of the comparison with measured readings of a comparative object and/or prediction of trends in growth of an animate or inanimate object or a portion thereof. Similar measurements may be obtained of the symphysis-pubis region of a pregnant woman to determine the normal growth patterns of a foetus. Other clinical applications possible by the system 100 may be: (i) Studying effects of maternal weight gain during pregnancy, (ii) Amniotic Fluid Index (AFI) Estimation, (iii) Estimated Fetal Weight (EFW) calculation, (iv) Prediction of multiple pregnancies, (v) Prediction of Macrosomia and (vi) Collecting LBW/IUGR data/trends in the Indian context. The measurements may be taken periodically and each of the measurements may be stored for the purposes of retrieval and comparison to determine growth, and for continually monitoring and predicting trends in growth.

The system 100 for measuring weight and volume of an animate or an inanimate object or a portion thereof, therefore, can be performed by unskilled technicians. The system 100 also reduces measurement errors due to accurate scanning of the object, and distributed load cells or pressure sensors. Also, the system 100 is comparatively less harmful in case of animate objects as no penetration of radiations takes place. Further, the system 100 is comparatively less expensive.

### TECHNICAL ADVANCES AND ECONOMICAL SIGNIFICANCE

The system for measuring and monitoring weight and volume of an object or a portion thereof, in accordance with the present disclosure described herein above has several technical and/or economic advantages including but not limited to the realization of a system that:
reduce measurement errors;
estimates the parameters of physical growth of the internal constituents of an object or its portion from only the physical measurements of the object or its portion externally;
performs in an optimal manner from time perspective;
is cost-effective;
is easy to understand and operate;
requires less trained worker;
less harmful in case of animate objects; and
is efficient and safe.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or mixtures or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form part of the prior art base or were common general knowledge in the field relevant to the disclosure, as it existed anywhere before the priority date of this application. The numerical value mentioned for the various physical parameters, dimensions or quantities are only approximations and it is envisaged that the values higher/lower than the numerical values assigned to the parameters, dimensions or quantities fall within the scope of the invention, unless there is a statement in the specification specific to the contrary.

The embodiment herein, the various features, and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced, and to further enable those of skill in the art to practice the embodiments herein. Accordingly, the examples should not be construed as limiting the scope of the embodiments herein.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for measuring and monitoring weight and volume of an object or a portion thereof at periodic intervals to track the growth of said object or a portion thereof, said system comprising:
a processor configured to receive predetermined set of rules from a rules repository and further configured to generate system processing commands;
a weight sensing unit configured to, under said system processing commands, measure load of said object or a portion thereof, and further configured to generate and transmit weight signals;
a volume sensing unit configured to, under said system processing commands, scan or capture images of said object or a portion thereof and further configured to generate contour signals corresponding to an outer profile of said scanned object or captured image of said object; and
a first data repository configured to store pre-determined set of mathematical formulae,
characterized in that:
said processor is configured to receive said weight signals to generate and store digital values of measured weight of said object or a portion thereof corresponding to received weight signals, said processor further configured to receive said mathematical formulae and said contour signals to compute and store volume of said object or a portion thereof corresponding to said contour signals using said mathematical formulae, said processor still further configured to compute the weight and volume of one or more of the internal constituents of the object or its portion thereof using the stored measured weight and the stored computed volume of the object or its portion thereof.

2. The system as claimed in claim 1, wherein said system further comprises:
a computational module configured to, under system processing commands, generate said digital values of weight and compute said volume of said object or a portion thereof periodically, using said mathematical formulae;
a second data repository configured to store said digital values of measured weight and said computed volume of said object or a portion thereof over a period of time; and
and a display unit configured to display said measured weight and computed volume.

3. The system as claimed in claim 1, said weight sensing unit is a flexible mattress defined by a plurality of slats, each of said plurality of slats having at least one load cell to measure load subjected thereon and configured to generate said weight signals corresponding to said measured load.

4. The system as claimed in claim 1, said weight sensing unit is an air mattress defined by a plurality of sections, each of said plurality of sections having at least one pressure sensor to measure load subjected thereon and configured to generate said weight signals corresponding to said measured load.

5. The system as claimed in claim 4, each of said plurality of sections is filled with air separately to measure load of portions of said object independently.

6. The system as claimed in claim 1, wherein said volume sensing unit comprises a scanner configured to scan said object or a portion thereof.

7. The system as claimed in claim 1, wherein said volume sensing unit comprises at least one camera configured to capture images of said object or portion thereof.

8. The system as claimed in claim 1, wherein said volume sensing unit comprises a laser beam source and a camera, said laser beam source configured to project a plurality of laser beams on said object or a portion thereof, and said camera configured to capture images of said plurality of laser beams impinged on said object or a portion thereof.

9. The system as claimed in claim 6, claim 7 or claim 8, wherein said volume sensing unit further comprises a frame on which said scanner or said camera or said laser beam source is mounted, said frame configured to traverse along the length of said object or a portion thereof.

10. The system as claimed in claim 9, wherein said frame comprises at least one arcuate rail on which said scanner or said camera or said laser beam source is mounted, said at least one arcuate rail configured to facilitate traversing of said scanner or said camera or said laser beam source along the width of said object or a portion thereof.
